(19) United States
(12) Patent Application Publication
(10) Pub. No.: US 2021/0304202 A1
(43) Pub. Date: Sep. 30, 2021

(54) SYSTEM AND METHOD FOR SECURING A VEHICLE TRANSACTION WITHIN BLOCKCHAIN

(71) Applicant: Honda Motor Co., Ltd., Tokyo (JP)

(72) Inventor: Boris Hernan Polania Castro, Cupertino, CA (US)

(21) Appl. No.: 16/830,728

(22) Filed: Mar. 26, 2020

(51) Int. Cl. G06Q 20/40; G06Q 20/36; G06Q 10/02; G06Q 50/30; H04L 9/06; H04L 9/08

(52) U.S. Cl. CPC G06Q 20/405; G06Q 20/36; G06Q 10/02; G06Q 50/30; G06Q 2240/00; H04L 9/0819; H04L 2209/38; H04L 2209/56; G06Q 2220/00; H04L 9/0643

(57) ABSTRACT

A system and method for securing a vehicle transaction within blockchain that include initiating a secure transaction between a vehicle and a sender of funds or a recipient of funds. The system and method also include processing a smart contract that is associated with the secure transaction. The system and method further includes communicating transaction data to complete the secure transaction using the blockchain to securely transfer funds from the sender to the vehicle or from the vehicle to the recipient.

### BACKGROUND

Traditional vehicle ownership patterns are changing and ride sharing is becoming more prevalent. As more people are starting to utilize ride sharing services proper securement of customer financial information is becoming a challenge. In many cases, people who use third-party applications to input and/or store financial data that is transferred to one or more entities to pay for ride-sharing may be at risk to data breaches that may compromise their identify and/or financial data. In some cases, complex data encryption may not be implemented to secure ride share financial transactions. Additionally, financial data may be susceptible to compromise based on one or more factors including an unsecure wireless access point and/or unsecure computing infrastructure.

### BRIEF DESCRIPTION

According to one aspect, a computer-implemented method for securing a vehicle transaction within blockchain that includes initiating a secure transaction between a vehicle and a sender of funds or a recipient of funds. The computer-implemented method also includes processing a smart contract that is associated with the secure transaction. The smart contract includes transaction data that is associated with the secure transaction. The computer-implemented method further includes communicating the transaction data to complete the secure transaction using the blockchain to securely transfer funds from the sender to the vehicle or from the vehicle to the recipient.

According to another aspect, a system for securing a secure key transaction within blockchain that includes a memory storing instructions when executed by a processor cause the processor to initiate a secure transaction between a vehicle and a sender of funds or a recipient of funds. The instructions also cause the processor to process a smart contract that is associated with the secure transaction. The smart contract includes transaction data that is associated with the secure transaction. The instructions further cause the processor to communicate the transaction data to complete the secure transaction using the blockchain to securely transfer funds from the sender to the vehicle or from the vehicle to the recipient.

According to yet another aspect, a non-transitory computer readable storage medium storing instructions that when executed by a computer, which includes a processor perform a method that includes initiating a secure transaction between a vehicle and a sender of funds or a recipient of funds. The method also includes processing a smart contract that is associated with the secure transaction. The smart contract includes transaction data that is associated with the secure transaction. The method further includes communicating the transaction data to complete the secure transaction using the blockchain to securely transfer funds from the sender to the vehicle or from the vehicle to the recipient.

### BRIEF DESCRIPTION OF THE DRAWINGS

The novel features believed to be characteristic of the disclosure are set forth in the appended claims. In the descriptions that follow, like parts are marked throughout the specification and drawings with the same numerals, respectively. The drawing figures are not necessarily drawn to scale and certain figures can be shown in exaggerated or generalized form in the interest of clarity and conciseness. The disclosure itself, however, as well as a preferred mode of use, further objects and advances thereof, will be best understood by reference to the following detailed description of illustrative embodiments when read in conjunction with the accompanying drawings, wherein:

FIG. 1 is a schematic view of an exemplary operating environment for securing a vehicle transaction within blockchain according to an exemplary embodiment of the present disclosure;

FIG. 2 is a schematic view of a plurality of modules of the vehicle transaction application that may execute computer-implemented instructions for securing the vehicle transaction within blockchain according to an exemplary embodiment of the present disclosure;

FIG. 3 is a process flow diagram of a method for securing a financial transaction between a sender reserving and utilizing a vehicle according to an exemplary embodiment of the present disclosure;

FIG. 4 is a process flow diagram of a method for securing a financial transaction associated with a loan of funds between a loaning entity and the vehicle according to an exemplary embodiment of the present disclosure; and

FIG. 5 is a process flow diagram of a method for securing a vehicle transaction within blockchain according to an exemplary embodiment of the present disclosure.

### DETAILED DESCRIPTION

The following includes definitions of selected terms employed herein. The definitions include various examples and/or forms of components that fall within the scope of a term and that can be used for implementation. The examples are not intended to be limiting.

A “bus,’ as used herein, refers to an interconnected architecture that is operably connected to transfer data between computer components within a singular or multiple systems. The bus may be a memory bus, a memory controller, a peripheral bus, an external bus, a crossbar switch, and/or a local bus, among others. The bus may also be a vehicle bus that interconnects components inside a vehicle using protocols such as Controller Area network (CAN), Media Oriented System Transport (MOST), Local Interconnect Network (LIN), among others.

“Computer communication,” as used herein, refers to a communication between two or more computing devices (e.g., computer, personal digital assistant, cellular telephone, network device) and may be, for example, a network transfer, a file transfer, an applet transfer, an email, a hypertext transfer protocol (HTTP) transfer, and so on. A computer communication may occur across, for example, a wireless system (e.g., IEEE 802.11), an Ethernet system (e.g., IEEE 802.3), a token ring system (e.g., IEEE 802.5), a local area network (LAN), a wide area network (WAN), a point-to-point system, a circuit switching system, a packet switching system, among others.

An “input device,” as used herein may include devices for controlling different vehicle features which include various vehicle components, systems, and subsystems. The term “input device” includes, but it not limited to: push buttons, rotary knobs, and the like. The term “input device” additionally includes graphical input controls that take place within a user interface which may be displayed by various types of mechanisms such as software and hardware based controls, interfaces, or plug and play devices.

A “memory,” as used herein may include volatile memory and/or nonvolatile memory. Non-volatile memory may include, for example, ROM (read only memory), PROM (programmable read only memory), EPROM (erasable PROM) and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDR SDRAM), and direct RAM bus RAM (DRRAM).

A “module,” as used herein, includes, but is not limited to, hardware, firmware, software in execution on a machine, and/or combinations of each to perform a function(s) or an action(s), and/or to cause a function or action from another module, method, and/or system. A module may include a software controlled microprocessor, a discrete logic circuit, an analog circuit, a digital circuit, a programmed logic device, a memory device containing executing instructions, and so on.

An “operable connection,” as used herein may include a connection by which entities are “operably connected”, is one in which signals, physical communications, and/or logical communications may be sent and/or received. An operable connection may include a physical interface, a data interface and/or an electrical interface.

An “output device,” as used herein may include devices that may derive from vehicle components, systems, subsystems, and electronic devices. The term “output devices” includes, but is not limited to: display devices, and other devices for outputting information and functions.

A “processor,” as used herein, processes signals and performs general computing and arithmetic functions. Signals processed by the processor may include digital signals, data signals, computer instructions, processor instructions, messages, a bit, a bit stream, or other means that may be received, transmitted and/or detected. Generally, the processor may be a variety of various processors including multiple single and multicore processors and co-processors and other multiple single and multicore processor and co-processor architectures. The processor may include various modules to execute various functions.

A “computer-readable medium”, as used herein, refers to a medium that provides signals, instructions and/or data. A computer-readable medium may take forms, including, but not limited to, non-volatile media and volatile media. Non-volatile media may include, for example, optical or magnetic disks, and so on. Volatile media may include, for example, semiconductor memories, dynamic memory, and so on. Common forms of a computer-readable medium include, but are not limited to, a floppy disk, a flexible disk, a hard disk, a magnetic tape, other magnetic medium, other optical medium, a RAM (random access memory), a ROM (read only memory), and other media from which a computer, a processor or other electronic device may read.

A “data store”, as used herein can be, for example, a magnetic disk drive, a solid state disk drive, a floppy disk drive, a tape drive, a Zip drive, a flash memory card, and/or a memory stick. Furthermore, the disk can be a CD-ROM (compact disk ROM), a CD recordable drive (CD-R drive), a CD rewritable drive (CD-RW drive), and/or a digital video ROM drive (DVD ROM). The disk can store an operating system that controls or allocates resources of a computing device. The data store can also refer to a database, for example, a table, a set of tables, a set of data stores (e.g., a disk, a memory, a table, a file, a list, a queue, a heap, a register) and methods for accessing and/or manipulating those data in those tables and data stores. The data store can reside in one logical and/or physical entity and/or may be distributed between two or more logical and/or physical entities.

A “vehicle” includes, but is not limited to: cars, trucks, vans, minivans, SUVs, motorcycles, scooters, boats, personal watercraft, and aircraft.

A “portable device”, as used herein, is a computing device typically having a display screen with user input (e.g., touch, keyboard) and a processor for computing. Portable devices include, but are not limited to, key fobs, handheld devices, mobile devices, smart phones, laptops, tablets and e-readers.

A “value” and “level”, as used herein may include, but is not limited to, a numerical or other kind of value or level such as a percentage, a non-numerical value, a discrete state, a discrete value, a continuous value, among others. The term “value of X” or “level of X” as used throughout this detailed description and in the claims refers to any numerical or other kind of value for distinguishing between two or more states of X. For example, in some cases, the value or level of X may be given as a percentage between 0% and 100%. In other cases, the value or level of X could be a value in the range between 1 and 10. In still other cases, the value or level of X may not be a numerical value, but could be associated with a given discrete state, such as “not X”, “slightly x”, “x”, “very x” and “extremely x”.

### I. System Overview:

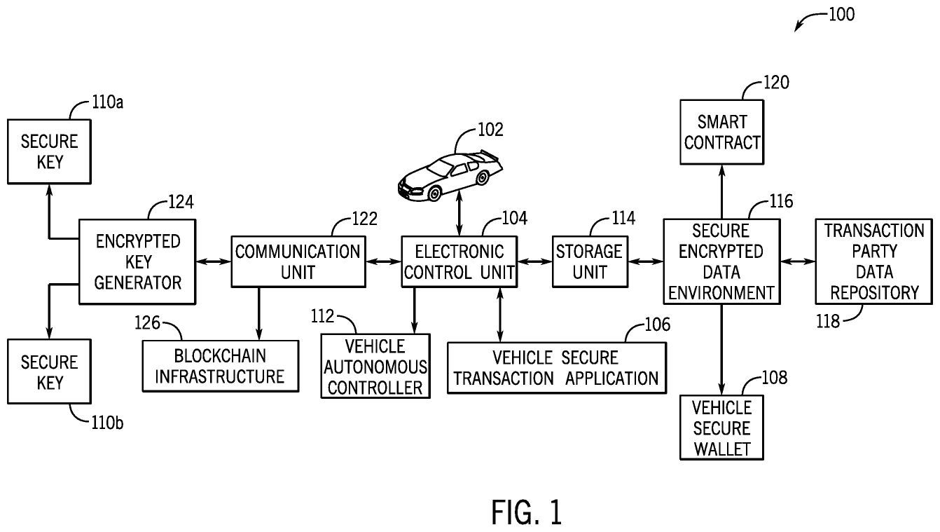

Referring now to the drawings, wherein the showings are for purposes of illustrating one or more exemplary embodiments and not for purposes of limiting the same, FIG. 1 is a schematic view of an exemplary operating environment 100 for securing a vehicle transaction within blockchain according to an exemplary embodiment of the present disclosure. In an exemplary embodiment, the operating environment 100 may include a vehicle 102 that may include an electronic control unit 104 that may be configured to execute a vehicle secure transaction application 106 (vehicle transaction application 106).

The vehicle 102 may be configured as an independent financial entity. In other words, the vehicle 102 may operate to manage its own funds and may be operated based on utilization of its own funds. As discussed in detail below, the vehicle transaction application 106 may facilitate independent self-funding and self-operation of the vehicle 102 by enabling secure financial transactions between one or more senders and the vehicle 102.

The one or more senders may include, the users, financial institutions, loan providers, additional vehicles, and/or one or more ownership entities (e.g., that may own the vehicle 102 as an asset) that may send funds to the vehicle 102 for one or more purposes. Such purposes may include but may not be limited to, payment for reservation/usage of the vehicle 102 (e.g., ride sharing), providing funds to loan an amount of money to the vehicle 102, providing funds to repay a loan provided by the vehicle 102, etc. In one or more embodiments, the vehicle 102 may be configured as an autonomous vehicle (e.g., self-driving vehicle) that may be configured to be reserved by one or more users through the vehicle transaction application 106 to transport the one or more users and/or objects from one location to another (e.g., as a ride sharing/transportation service) for one or more particular periods of time.

The vehicle 102 may also be independently financially sourced to facilitate payment of operating costs to one or more recipients of funds from the vehicle 102. Such operating costs may be securely paid through the application 106 to one or more recipients (e.g., vendors) to maintain operating standards of the vehicle 102 that may include, but may not be limited to, refueling, re-charging, fluid maintenance (e.g., oil change, coolant change), component maintenance (e.g., brake maintenance, tire maintenance), and the like that may enable the vehicle 102 to maintain proper operating standards.

The vehicle 102 may additionally be independently financially sourced to facilitate payment of transporting costs. The transporting costs may be securely paid through the application 106 to one or more recipients (e.g., agencies, vendors) to maintain transporting standards that may include, but may not be limited to, payment of tolls, payment of parking fees, payment of vehicle registration fees, and the like that may enable the vehicle 102 to travel on one or more roadways and/or park at one or more locations.

As discussed in detail below, the vehicle transaction application 106 may facilitate independent self-funding and self-operation of the vehicle 102 by enabling secure financial transactions between the vehicle 102 and one/or more recipients that may be utilized to continually operate the vehicle 102. The one or more recipients may include, toll authorities, fueling stations, electric charging providers, loan providers, additional vehicles, and/or one or more ownership entities that may receive funds from the vehicle 102 for one or more purposes.

As discussed below, the vehicle transaction application 106 may be configured to store a vehicle secure wallet (secure wallet) 108 that may be associated with the vehicle 102 and may be linked to a third-party financial account that may be stored in an externally hosted secure location (e.g., banking institution infrastructure). The secure wallet 108 may be configured as a virtual secure account that may store an amount of funds that may be associated with the vehicle 102 itself. The secure wallet 108 may be also configured to receive funds (e.g., credit) through one or more senders and/or may be a source from which funds are provided to one or more recipients. Accordingly, the secure wallet 108 may be a central source of receiving funds for reservations of the vehicle 102, usage of the vehicle 102 (e.g., by the user(s)), and/or receiving loans that may be loaned to the vehicle 102. The secure wallet 108 may also be a central source to pay for operating costs, transporting costs, to provide funds to the one or more ownership entities, and/or to pay back loans that may be loaned to the vehicle 102.

The vehicle transaction application 106 may facilitate reservation and usage of the vehicle 102 by one or more users and may be configured to calculate a usage fee of the vehicle 102 that may be charged to the user(s) to enable the vehicle 102 to be funded (e.g., paid) for the reservation and usage of the vehicle 102. The usage fee may be calculated based on one or more operating and transporting factors such as a timeframe when the vehicle 102 is reserved, a length of time of the reservation of the vehicle 102, one or more operating costs that may be determined based on a predetermined calculation that may be associated with depreciation, wear and tear, vehicle dynamics during the reservation (e.g., brake usage, miles traveled), one or more transporting costs associated with the utilization of the vehicle 102, and/or the physical condition of the vehicle 102 (e.g., cleanliness of an interior cabin of the vehicle 102). The application 106 may enable the secure transfer of funds from the user(s) reserving the vehicle 102 to the vehicle 102.

The vehicle transaction application 106 may additionally monitor an amount of funds that may be held at a particular point in time within the secure wallet 108 and may determine if the amount of funds is equal to or above a baseline self-funding threshold (funding threshold). The funding threshold may include a requisite amount of funds for the vehicle 102 to self-operate in order to facilitate payment of operating costs, transporting costs, and/or loan repayments to one or more recipients. As discussed below, if the application 106 determines that a current amount of funds within the secure wallet 108 falls below the funding threshold, the application 106 may enable the vehicle 102 to request a loan from one or more senders to allow the vehicle 102 to have a requisite amount of funds for the vehicle 102 to self-operate. The application 106 may further enable the vehicle 102 to facilitate repayment of the loan with an interest amount to pay back one or more of the senders who provided the vehicle 102 with the loan as one or more recipients.

The vehicle transaction application 106 may further facilitate the secure transfer of funds from the vehicle 102 to one or more recipients to maintain operating standards such as refueling, re-charging, fluid maintenance, component maintenance, and the like. The application 106 may further facilitate the secure transfer of funds from the vehicle 102 to one or more recipients to maintain transporting standards such as payment of tolls to travel on one or more roadways and/or park at one or more locations.

In one or more embodiments, upon facilitating the reception of funds by the vehicle 102 and/or the sending of funds by the vehicle 102, the vehicle transaction application 106 may be configured to initiate a secure transaction between the vehicle 102 and the one or more senders and/or the one or more recipients to complete a financial transaction of funds. The application 106 may be configured to process a smart contract 120 that may be associated with the secure transaction. The smart contract 120 may be configured as a self-executing contract with the terms of agreement that may be associated with the transfer of funds from the sender(s) to the vehicle 102 and/or from the vehicle 102 to the recipient(s). In particular, the smart contract 120 may be configured as a computerized transaction protocol that executes terms of a contract that may be associated with the transfer of funds through blockchain to and/or from the vehicle 102. The smart contract 120 may include some select information (e.g., sender/recipient information) that may be determined from a transaction party data repository 118 (discussed below) and may be passed through blockchain.

For example, the smart contract 120 may include one or more terms associated with a payment that may be made from a user to the vehicle 102 including the user's name and associated information, a payment amount, one or more financial accounts. As another example, the smart contract 120 may include one or more terms that may be associated with a loan that may be provided to the vehicle 102 such as a loan amount, a loan term, an interest rate, a payment cycle, and the like.

The vehicle transaction application 106 may additionally be configured to generate a secure encrypted data key (secure key) 110a that may be assigned to one or more senders and/or one or more recipients that are participating in the secure transaction with the vehicle 102 to validate the secure transaction of funds to the vehicle 102 and/or from the vehicle 102. The application 106 may also be configured to generate a secure key 110b that may be associated to the vehicle 102 to validate the secure transaction of funds from one or more senders and/or to one or more recipients. Each of the secure keys 110a, 110b may be encrypted with a numerical encrypted key code or alpha-numerical encrypted key code that may not be publically accessible. As discussed below, the secure keys 110a, 110b may be exchanged as ownership credentials to securely validate the financial transaction between the sender and the vehicle 102 and/or the vehicle 102 and the recipient.

With continued reference to FIG. 1, the ECU 104 of the vehicle 102 may be configured to control one or more components of the vehicle 102. The ECU 104 may include internal processing memory, an interface circuit, and bus lines for transferring data, sending commands, and communicating with the plurality of components of the vehicle 102. In one embodiment, the ECU 104 may be configured to operably communicate with a vehicle autonomous controller 112 of the vehicle 102. The vehicle autonomous controller 112 may be configured to execute autonomous driving commands to operate the vehicle 102 to autonomously control one or more driving functions of the vehicle 102. The vehicle autonomous controller 112 may communicate with one or more sensors of the vehicle 102 including, but not limited to, GPS sensors, image sensors, LiDAR sensors, radar sensors, pressure sensors, etc. (sensors not shown) and may control one or more driving functions that may include, but may not be limited to steering, braking, accelerating, merging, turning, coasting, and the like to navigate the vehicle 102 to one or more locations.

In one embodiment, the vehicle transaction application 106 may be configured to present a human machine interface (HMI) through one or more user interfaces. In one configuration, the vehicle transaction application 106 may be configured to present a reservation user interface that may be presented on a computing device/portable device (not shown) and/or within the vehicle 102 that may be used by one or more potential users of the vehicle 102. The reservation user interface may allow the user(s) to reserve the vehicle 102 and/or an additional vehicle that may be available for usage (e.g., that may not already be reserved and/or being utilized). The reservation user interface may allow the user(s) to input a pickup location and an estimated length of time that the user(s) is planning to utilize the vehicle 102. Such an input may be provided through user interface inputs (e.g., typing, touchpad inputs, mouse inputs, touch screen inputs) and/or verbal inputs (e.g., verbal commands). Accordingly, based on user inputs provided to the reservation user interface, the vehicle transaction application 106 may be configured to communicate with the vehicle autonomous controller 112 to autonomously navigate to one or more locations.

In one or more embodiments, during an active reservation and utilization of the vehicle 102, the vehicle transaction application 106 may be configured to present an active reservation user interface that may allow the user(s) to input one or more destinations, reduce or extend the reservation of the vehicle 102, and/or input a final destination drop-off point of the user(s). Such an input may also be provided through user interface inputs and/or verbal inputs provided within the vehicle 102 and/or through the computing device/portable device used by the user(s). Based on user inputs provided to the active reservation user interface, the vehicle transaction application 106 may be configured to communicate with the vehicle autonomous controller 112 to autonomously navigate to one or more locations.

In one embodiment, the ECU 104 may be operably connected to a storage unit 114 of the vehicle 102. The storage unit 114 may be configured to store data files associated with one or more applications, operating systems, financial systems, financial system user interfaces, including but not limited to data files of the vehicle transaction application 106. In one embodiment, the storage unit 114 may be configured to store a secure encrypted data environment 116 of the vehicle transaction application 106. The secure encrypted data environment 116 may be configured as an encrypted data store that may be associated with a secure transfer of funds to the vehicle 102 from one or more senders and/or from the vehicle 102 to one or more recipients.

The secure encrypted data environment 116 may be utilized as an encrypted data container that may enable the vehicle transaction application 106 to securely store the secure wallet 108 that may be accessed during each respective secure transaction. The secure wallet 108 may be configured as an encrypted data packet that may store a digitally encrypted value associated with an amount of funds that may be associated with the vehicle 102. The secure wallet 108 may also include selective transaction data that may include, but may not be limited to, a monetary transfer amount, account information, wiring information, routing information, and the like associated with the financial transaction from one or more senders to the vehicle 102 and/or from the vehicle 102 to one or more recipients. In an exemplary embodiment, the application 106 may be configured to access the secure wallet 108 to credit funds and/or debit funds to/from the secure wallet 108 once secure validation is completed of the secure transaction between the vehicle 102 and one or more senders and/or one or more recipients based on an exchange of the secure keys 110a, 110b.

In an exemplary embodiment, the secure encrypted data environment 116 may additionally be configured to store the smart contract 120 upon being processed by the application 106. The smart contract 120 may be configured as a self-executing contract with the terms of agreement that may be associated with the transfer of funds from the sender(s) to the vehicle 102 and/or from the vehicle 102 to the recipient(s). As discussed below, the vehicle transaction application 106 may be configured to access the secure encrypted data environment 116 to retrieve the smart contract 120 upon the exchange of the secure keys 110a, 110b to be passed through blockchain.

In one or more embodiments, the secure encrypted data environment 116 may also be configured to store the transaction party data repository 118. The transaction party data repository 118 may include data that pertains to one or more senders that may utilize the application 106 to securely transfer funds to the secure wallet 108 of the vehicle 102. For example, the transaction party data repository 118 may include data that pertain to one or more users that may utilize the vehicle transaction application 106 to reserve and utilize the vehicle 102.

In one embodiment, an individual/entity that would like to initiate a secure transaction to send funds to the vehicle 102 may initially utilize the vehicle transaction application 106 to reserve and utilize the vehicle 102 or securely transfer funds to the vehicle 102 (e.g., to make a payment(s) to the vehicle 102, to provide a loan(s) to the vehicle 102). During an initial use of the application 106 by the individual/entity, the vehicle transaction application 106 may present a sender profile setup user interface that may be presented to the individual/entity as a sender or may utilize a communication unit 122 of the vehicle 102 to populate a sender profile (not shown) associated with the individual as the sender. In particular, the sender profile may be populated with information including, but not limited to, the sender name (e.g., name of the user reserving the vehicle 102), address, phone number, associated account information (e.g., credit card account(s)), banking institutions, wiring information, routing information, transfer timeframe information, and the like.

Similarly, upon the vehicle 102 initiating an initial secure transfer of funds to one or more recipients through the vehicle transaction application 106, the application 106 may present a recipient profile setup user interface that may be presented to the respective party or may utilize the communication unit 122 of the vehicle 102 to populate a recipient profile (not shown) associated with the respective recipient. In particular, the recipient profile may be populated with information including, but not limited to, the recipient name (e.g., name of the recipient receiving funds from the vehicle 102), address, phone number, associated account information (e.g., credit card account(s)), banking institutions, wiring information, routing information, transfer timeframe information, and the like.

In one or more embodiments, based on the utilization of the application 106 to securely transfer funds to the vehicle 102 from a particular sender and/or securely transfer funds from the vehicle 102 to a particular recipient, the vehicle transaction application 106 may be configured to access a respective sender profile and/or recipient profile to utilize the information stored within the profile(s) to populate the smart contract 120 that may be associated with the secure transaction.

In an exemplary embodiment, the communication unit 122 of the vehicle 102 may be configured to connect to externally hosted computing systems (not shown) that may be associated with one or more senders and/or one or more recipients. Such computing systems may include, but may not be limited to, portable device(s)/computing device(s) used by user(s) who may use the application 106 to reserve and utilize the vehicle(s) 102, server infrastructure used by financial institutions, loan providers, ownership entities that may send funds to the vehicle 102 and/or receive funds from the vehicle 102, and/or electronic control units of additional vehicles that may communicate with the vehicle 102 through respective communication units.

In one embodiment, the vehicle transaction application 106 may be configured to utilize the communication unit 122 to present the user interface of the application 106 during an initial use of the vehicle transaction application 106 to input profile information that may be populated within the sender profile or the recipient profile. Such profile information may be associated with the sender name, recipient name, address, banking instruction(s), and the like. The user interface may also allow the sender or the recipient to link one or more respective financial accounts and associated account information to the vehicle transaction application 106.

In one embodiment, the vehicle transaction application 106 may be configured to utilize the communication unit 122 to present a secure transfer user interface of the application 106 to one or more senders to initiate the secure transfer of funds to the vehicle 102. Additionally, the vehicle transaction application 106 may be configured to utilize the communication unit 122 to present the secure transfer user interface to one or more recipients to accept the secure transfer of funds from the vehicle 102.

In one embodiment, the vehicle transaction application 106 may be configured to utilize the communication unit 122 to present the reservation user interface that may be presented to one or more potential users of the vehicle 102 that may allow the user(s) to reserve the vehicle 102. The vehicle transaction application 106 may also be configured to utilize the communication unit 122 to present the secure transfer user interface of the application 106 to allow the user(s) to securely transfer funds associated with the reservation and utilization of the vehicle 102 to the secure wallet 108 of the vehicle 102.

As discussed below, in one configuration, the vehicle transaction application 106 may be configured to utilize the communication unit 122 to present a loan request user interface that may be presented to one or more entities to request a loan. In particular, if the application 106 determines that the current amount of funds within the secure wallet 108 falls below the funding threshold (discussed above), the application 106 may utilize the communication unit 122 to request a loan from one or more individuals/entities/additional vehicles to allow the vehicle 102 to have a requisite amount of funds for the vehicle 102 to self-operate. For example, if the application 106 determines that the current amount of funds within the secure wallet 108 falls below the funding threshold, the application 106 may be configured to utilize the communication unit 122 to communicate with the server infrastructure used by financial institutions and/or loan providers to present the loan request user interface to request the loan.

The loan request user interface may include one or more loan terms that may be requested including, but not limited to, an amount of funds as calculated by the application 106, a timeframe term of the loan, and/or additional terms (e.g., down payment, additional fees). The loan request user interface may enable one or more source providers to selective accept the loan request or deny the loan request. Additionally, the loan request user interface may enable one or more source providers to input respective loan terms such as an interest rate, loan start date, final payment date, and/or one or more additional terms to enable the secure transfer of funds to the vehicle 102 through the application 106.

In one or more embodiments, the vehicle transaction application 106 may include an encrypted key generator 124. The encrypted key generator 124 may be configured to generate the secure key 110a that may be associated with the sender and/or the recipient and the secure key 110b that may be associated with the vehicle 102. The encrypted key generator 124 may process the secure keys 110a, 110b with a numerical encrypted key code or alpha-numerical encrypted key code (e.g., n digit alpha-numeric code) that may not be publically accessible.

The secure keys 110a, 110b may be exchanged as ownership credentials to securely validate the financial transaction between the sender and the vehicle 102 and/or the vehicle 102 and the recipient without the sender and/or the recipient being able to access the secure keys 112a, 112b. In one configuration, the vehicle transaction application 106 may utilize the communication unit 122 to transfer the secure key 110a to the vehicle 102 to authenticate the sender and/or recipient to complete secure transaction. The vehicle transaction application 106 may also utilize the communication unit 122 to transfer the secure key 110b to the sender and/or the recipient to authenticate the vehicle 102 to complete the secure transaction.

As discussed below, the vehicle transaction application 106 may be configured to pass the financial transaction between the sender and the vehicle 102 and/or the vehicle 102 and the recipient using blockchain through blockchain infrastructure 126. In one or more embodiments, the blockchain infrastructure 126 may be configured to include one or more externally hosted computing systems that may be owned, operated, and/or hosted by one or more blockchain technology providers. In one embodiment, upon securely validating the financial transaction between the sender and the vehicle 102 and/or the vehicle 102 and the recipient through the exchanging of the secure keys 110a, 110b between the vehicle 102 and the sender and/or the recipient, the application 106 may utilize the communication unit 122 to transfer the smart contract 120 containing the transaction data associated with the secure transaction through a blockchain technology. The smart contract 120 may thereby be transferred through the blockchain infrastructure 126 to complete the financial transaction between the sender and the vehicle 102 (e.g., transferring funds to the vehicle 102 from a sender) and/or the vehicle 102 and the recipient (e.g., transferring funds from the vehicle 102 to a recipient) in an encrypted and secure manner using blockchain.

As an illustrative example, the smart contract 120 may thereby be transferred through the blockchain infrastructure 126 to complete the financial transaction between a user and the vehicle 102 to pay for a reservation and utilization of the vehicle 102 for a period of time. Accordingly, information pertaining to the smart contract 120 and the transfer of funds from the user to the secure wallet 108 of the vehicle 102 may be passed through blockchain via the blockchain infrastructure 126.

### II. The Vehicle Secure Transaction Application and Methods Executed By the Application

The vehicle transaction application 106 and its components will now be discussed in more detail according to an exemplary embodiment and with continued reference to FIG. 1. In one or more embodiments, the vehicle transaction application 106 may be stored on the storage unit 114 of the vehicle 102 and may be executed by the ECU 104 of the vehicle 102. In another embodiment, the vehicle transaction application 106 may be stored on an externally hosted server infrastructure (not shown) or one or more computing systems of the blockchain infrastructure 126 and may be accessed by the vehicle 102 through the communication unit 122 to be executed by the ECU 104 of the vehicle 102. In yet some additional embodiments, the vehicle transaction application 106 may be stored on the storage unit 114 of the vehicle 102, one or more computing devices of the blockchain infrastructure 126, the portable device(s), and/or computing device(s)/infrastructure used by the sender(s) and/or the recipient(s).

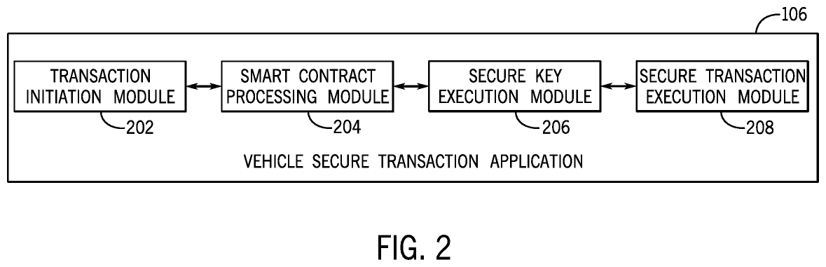

FIG. 2 is a schematic view of a plurality of modules 202-208 of the vehicle transaction application 106 that may execute computer-implemented instructions for securing a vehicle transaction within blockchain according to an exemplary embodiment of the present disclosure. In an exemplary embodiment, the plurality of modules 202-208 may include a transaction initiation module 202, a smart contract processing module 204, a secure key execution module 206, and a secure transaction execution module 208. It is appreciated that the vehicle transaction application 106 may include one or more additional modules and/or sub-modules that are included in addition to or in lieu of the modules 202-208.

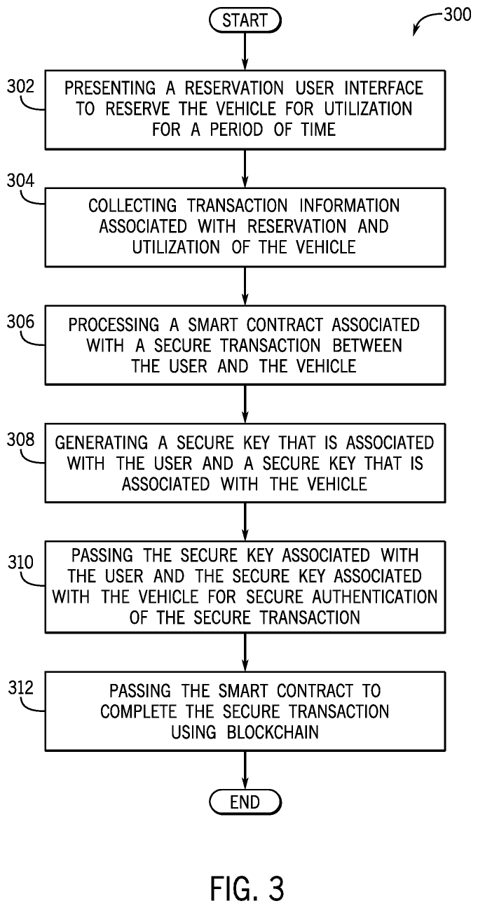

FIG. 3 is a process flow diagram of a method 300 for securing a financial transaction between a sender reserving and utilizing the vehicle 102 according to an exemplary embodiment of the present disclosure. FIG. 3 will be described with reference to the components of FIG. 1 and FIG. 2, through it is appreciated that the method 300 of FIG. 3 may be used with additional and/or alternative system components. The method 300 may begin at block 302, wherein the method 300 may include presenting a reservation user interface to reserve the vehicle 102 for utilization for a period of time.

In an exemplary embodiment, the transaction initiation module 202 of the vehicle transaction application 106 may be configured to present a transaction initiation user interface that may be utilized by the sender and/or the recipient to initiate a secure transaction with the vehicle 102 through the vehicle transaction application 106. In particular, the transaction initiation user interface may be presented to the sender (e.g., through the user's portable device/computing device) to initiate a financial transaction (e.g., that is initiated by the sender) that may be utilized to securely transfer an amount of funds to the vehicle 102. In particular, the transaction initiation user interface may be configured to provide respective user interface input icons that may be inputted to provide respective types of financial transactions, including, but not limited to, a reservation transaction, a loan transaction, a payment transaction, and the like.

In one embodiment, if it is determined that the user interface input icon that may be associated with the reservation transaction is inputted by a user, the vehicle transaction application 106 may be configured to present a reservation user interface that may be presented on the user's computing device/portable device. The method 300 may proceed to block 304, wherein the method 300 may include collecting transaction information associated with reservation and utilization of the vehicle 102.

In one embodiment, the reservation user interface may allow the user to input data associated with the reservation and utilization of the vehicle 102, including but not limited to, a pickup location and an estimated length of time that the user is planning to utilize the vehicle 102, one or more intermediary destinations of the vehicle 102, a final destination/drop-off location. Such an input may be provided through user interface inputs and/or verbal inputs. Additionally, during an active reservation and utilization of the vehicle 102, the transaction initiation module 202 may be configured to present the active reservation user interface that may allow the user to input or edit data associated with the active reservation and utilization of the vehicle 102, including, but not limited to, one or more intermediary destinations, a change in the length of time of the reservation of the vehicle 102, a change in a final destination drop-off point of the user.

In one or more embodiments, the transaction initiation module 202 may be configured to analyze the inputted data associated with the reservation and utilization of the vehicle 102 received through the reservation user interface and/or the active reservation user interface and may collect the data as transaction data points associated with the reservation and utilization of the vehicle 102. The transaction data points may be stored upon the storage unit 114 of the vehicle 102. In one embodiment, upon the drop-off of the vehicle 102, the transaction initiation module 202 may evaluate the transaction data points stored on the storage unit 114 and data associated with the usage of the vehicle 102 during the reservation and utilization of the vehicle 102 to calculate a usage fee that may be charged to the user for the reservation and utilization of the vehicle 102. As discussed above, the usage fee may enable the vehicle 102 to be funded based on a secure transfer of funds from the user to the vehicle 102.

In particular, the usage fee may be calculated based on one or more operating and transporting factors that may be derived from the transaction data points stored upon the storage unit 114 such as a timeframe when the vehicle 102 is reserved, a length of time of the reservation of the vehicle 102, one or more operating costs that may be determined based on a predetermined calculation that may be associated with depreciation, wear and tear, vehicle dynamics during the reservation (e.g., brake usage, miles traveled), one or more transporting costs associated with the utilization of the vehicle 102, and/or the physical condition of the vehicle 102.

The method 300 may proceed to block 306, wherein the method 300 may include processing a smart contract 120 associated with the secure transaction between the user and the vehicle 102. In an exemplary embodiment, upon storing the transaction data points and calculating the usage fee associated with the reservation and utilization of the vehicle 102, the transaction initiation module 202 may communicate respective data to the smart contract processing module 204 of the vehicle transaction application 106. In one embodiment, the smart contract processing module 204 may process the smart contract 120 that pertains to the secure transaction associated with the payment of the usage fee from the user to the vehicle 102.

The smart contract 120 may be configured as a self-executing contract that may include terms of agreement that may be associated with the transfer of funds (associated with the usage fee) from the user to the vehicle 102. In one configuration, the smart contract processing module 204 may access the transaction party data repository 118 to query the repository 118 for a sender profile that may be associated with the user. As discussed above, the sender profile may be populated with information including, but not limited to, the sender name (e.g., name of the user reserving the vehicle 102), address, phone number, associated account information (e.g., credit card account(s)), banking institutions, wiring information, routing information, transfer timeframe information, and the like.

Upon retrieving the sender profile, the smart contract processing module 204 may be configured to populate the processed smart contract 120 with selected information that may be extracted from the sender profile. Additionally, the smart contract processing module 204 may be configured to populate the smart contract with selected information associated with the transaction data points and the usage fee associated with the reservation and utilization of the vehicle 102. For example, the smart contract 120 may include one or more terms associated with a payment that may be made from the user to the vehicle 102 including the user's name and associated information, the usage fee amount, information pertaining to one or more financial accounts that may be linked to the user that may include credit card account(s) information, banking institutions information, wiring information, routing information, transfer timeframe information, and the like. In an exemplary embodiment, upon processing the smart contract 120, the smart contract processing module 204 may be configured to access the secure encrypted data environment 116 of the storage unit 114 to store an encrypted version of the smart contract 120 within the secure encrypted data environment 116.

The method 300 may proceed to block 308, wherein the method 300 may include generating a secure key 110a that is associated with the user and a secure key 110b that is associated with the vehicle 102. In one or more embodiments, upon processing and storing the smart contract 120, the smart contract processing module 204 may be configured to communicate data pertaining to the storage of the encrypted version of the smart contract 120 within the secure encrypted data environment 116 to the secure key execution module 206 of the vehicle transaction application 106.

In one or more embodiments, the secure key execution module 206 may thereby utilize the encrypted key generator 124 to generate the secure key 110a that may be associated with the user and the secure key 110b that may be associated with the vehicle 102. The encrypted key generator 124 may electronically generate the secure keys 110a, 110b that pertain to the secure transaction with a numerical encrypted key code or an alpha-numerical encrypted key code that may not be publically accessible.

The method 300 may proceed to block 310, wherein the method 300 may include passing the secure key 110a associated with the user and the secure key 110b associated with the vehicle 102 for secure authentication of the secure transaction. In an exemplary embodiment, upon the generation of the secure keys 110a, 110b, the secure key execution module 206 may be configured to exchange the secure keys 110a, 110b as ownership credentials to securely authenticate the transaction as a secure transaction between the user and the vehicle 102. In one configuration, the secure key execution module 206 may utilize the communication unit 122 to transfer the user's secure key 110a to the vehicle 102 to securely authenticate the user as the sender. The secure key execution module 206 may also be configured to transfer the secure key 110b to the user through the user's portable device/computing device to enable the acceptance of funds from the user to the vehicle 102. In some configurations, the secure key execution module 206 may also be configured to encrypt the respective secure keys 110a, 110b to financial records that are associated with the secure transaction.

The method 300 may proceed to block 312, wherein the method 300 may include passing the smart contract 120 to complete the secure transaction using blockchain. In an exemplary embodiment, upon passing the secure keys 110a, 110b for secure authentication of the secure transaction, the secure key execution module 206 may communicate data pertaining to the secure authentication of the secure transaction to the secure transaction execution module 208 of the vehicle transaction application 106.

In one embodiment, upon receiving the data pertaining to the secure authentication of the secure transaction, the secure transaction execution module 208 may be configured to access the secure encrypted data environment 116 to retrieve the smart contract 120 previously processed and stored within the secure encrypted data environment 116 (as discussed above, with respect to block 306). As discussed above, the smart contract 120 may include one or more terms associated with a payment that may be made from the user to the vehicle 102 that may be derived from the transaction data points and the usage fee associated with the reservation and utilization of the vehicle 102. In some configurations, the smart contract 120 may be retrieved in the form of one or more encrypted data packets that may be decrypted by the application 106 and/or the blockchain infrastructure 126.

In an exemplary embodiment, the secure transaction execution module 208 may be configured to utilize the communication unit 122 to pass the smart contract 120 (in the form of one or more encrypted data packets) to the blockchain infrastructure 126 to complete the secure transaction through the blockchain technology in an encrypted and secure manner using blockchain. The transaction data points and the usage fee associated with the reservation and utilization of the vehicle 102 included within the smart contract 120 may be further verified through the blockchain technologies to complete secure payment of funds from one or more financial accounts associated with the user to the secure wallet 108 of the vehicle 102. Accordingly, the vehicle transaction application 106 may ensure that the vehicle transaction is secure to a final payment point through the use of blockchain.

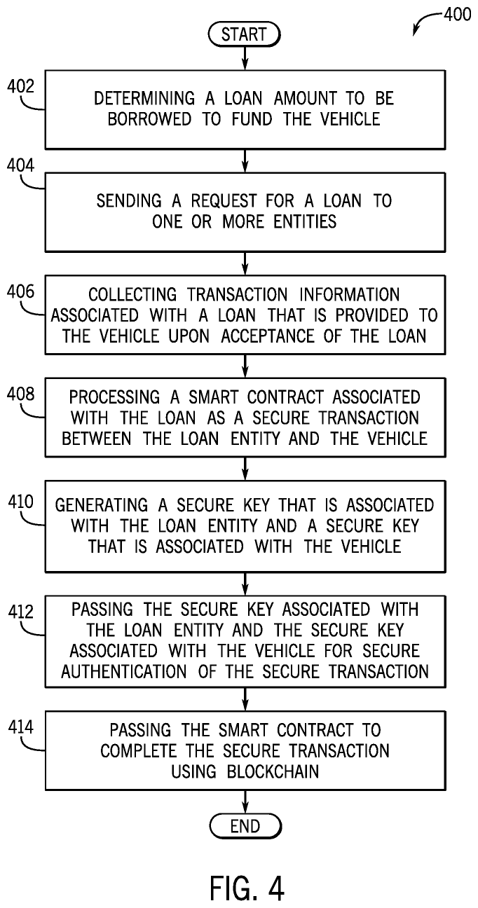

FIG. 4 is a process flow diagram of a method 400 for securing a financial transaction associated with a loan of funds between a loaning entity and the vehicle 102 according to an exemplary embodiment of the present disclosure. FIG. 4 will be described with reference to the components of FIG. 1 and FIG. 2, through it is appreciated that the method 400 of FIG. 4 may be used with additional and/or alternative system components. The method 400 may begin at block 402, wherein the method 400 may include determining a loan amount to be borrowed to fund the vehicle 102.

In an exemplary embodiment, upon facilitating a secure transaction between the vehicle 102 and one or more recipients (e.g., to complete payment of operating costs and/or transporting costs), the secure transaction execution module 208 may communicate respective data to the transaction initiation module 202 regarding the payment of funds from the secure wallet 108 to the recipient(s). The transaction initiation module 202 may thereby be configured to access the secure wallet 108 of the vehicle 102 stored upon secure encrypted data environment 116 to evaluate an amount of funds that may be held upon the completion of the secure transaction to determine if the amount of funds is equal to or above the funding threshold.

In one embodiment, if the transaction initiation module 202 determines that the amount of funds that may be held within the secure wallet 108 is below the funding threshold, the transaction initiation module 202 may be configured to determine a requisite amount of funds for the vehicle 102 to self-operate in order to facilitate payment of operating costs and/or transporting costs to one or more recipients. The operating costs may include projected estimated costs that may be associated with maintaining operating standards such as refueling, re-charging, fluid maintenance, component maintenance, and the like during a particular timeframe and/or distance (e.g., for the next month, the next three-thousand miles). The transporting costs may include projected estimated costs that may be associated payment of tolls to travel on one or more roadways, park at one or more locations, and the like during the particular timeframe and/or the distance.

The method 400 may proceed to block 404, wherein the method 400 may include sending a request for a loan to one or more entities. In an exemplary embodiment, upon determining the requisite amount of funds for the vehicle 102 to self-operate, the transaction initiation module 202 may be configured to utilize the communication unit 122 of the vehicle 102 to present a loan request user interface that may be presented to one or more entities to request a loan through a respective portable device/computing device/server infrastructure. The loan request user interface may include one or more loan terms that may be requested. The one or more loan terms may include, but may not be limited to, the loan amount to be borrowed to fund the vehicle 102, a timeframe term of the loan, and/or additional terms (e.g., down payment, additional fees). The loan request user interface may enable one or more loan entities to selective accept the loan request or deny the loan request.

The method 400 may proceed to block 406, wherein the method 400 may include collecting transaction information associated with the loan that is provided to the vehicle 102 upon acceptance of the loan. If one or more of the loan entities accept the loan request, the loan request user interface may enable one or more loan entities to input respective loan terms such as an interest rate, loan start date, final payment date, and/or one or more additional terms of the loan. In one embodiment, the transaction initiation module 202 may selectively accept or reject the loan terms based on one or more loan execution settings that may be preselected by one or more ownership entities of the vehicle 102. In some configurations, if the loan terms are rejected by the transaction initiation module 202, the module 202 may propose new loan terms that may be based on the one or more loan execution settings to be proposed to the loaning entity for acceptance or denial through the loan request user interface.

In one embodiment, if a loan entity accepts the loan request and the loan terms are accepted by the transaction initiation module 202, the transaction initiation module 202 may be configured to analyze the inputted data associated with the loan amount to be borrowed. The module 202 may also analyze the loan terms accepted by the module 202 and/or the loan entity and may collect the data as transaction data points associated with the loan of funds that may be provided to the vehicle 102. The transaction data points associated with the loan of funds may be stored upon the storage unit 114 of the vehicle 102.

The method 400 may proceed to block 408, wherein the method 400 may include processing a smart contract 120 associated with the loan as a secure transaction between the loan entity and the vehicle 102. In one embodiment, the smart contract processing module 204 may process a smart contract 120 that is associated with the secure transaction that pertains to the loaning of funds from the loan entity to the vehicle 102. The smart contract 120 may be configured as a self-executing contract with the terms of agreement that may be associated with the transfer of funds (associated with the loan) from the loan entity to the vehicle 102.

In one configuration, the smart contract processing module 204 may access the transaction party data repository 118 to query the repository 118 for a sender profile that may be associated with the loan entity and may be configured to populate the smart contract 120 with selected information that may be extracted from the sender profile. Additionally, the smart contract processing module 204 may be configured to populate the smart contract with selected information from the transaction data points associated with the loan that may be provided to the vehicle 102. For example, the smart contract 120 may include one or more terms that may be associated with the loan that may be provided to the vehicle 102 such as the loan amount, a loan term, an interest rate, a payment cycle, and the like.

The method may proceed to block 410, wherein the method 400 may include generating a secure key 110a that is associated with the loan entity and a secure key 110b that is associated with the vehicle 102. In one or more embodiments, the secure key execution module 206 may thereby utilize the encrypted key generator 124 to generate the secure key 110a that may be associated with the loan entity and the secure key 110b that may be associated with the vehicle 102. The encrypted key generator 124 may electronically generate the secure keys 110a, 110b that pertain to the secure transaction with a numerical encrypted key code or an alpha-numerical encrypted key code that may not be publically accessible.

The method 400 may proceed to block 412, wherein the method 400 may include passing the secure key 110a associated with the loan entity and the secure key 110b associated with the vehicle 102 for secure authentication of the secure transaction. In one embodiment, upon the generation of the secure keys 110a, 110b, the secure key execution module 206 may be configured to exchange the secure keys 110a, 110b as ownership credentials to securely authenticate the loan of funds to the vehicle 102 as a secure transaction between the user and the vehicle 102.

The method 400 may proceed to block 414, wherein the method 400 may include passing the smart contract 120 to complete the secure transaction using blockchain. In an exemplary embodiment, upon passing the secure keys 110a, 110b for secure authentication of the secure transaction, the secure transaction execution module 208 may be configured to utilize the communication unit 122 to pass the smart contract 120 (in the form of one or more encrypted data packets) to the blockchain infrastructure 126 to complete the secure transaction through the blockchain technology in an encrypted and secure manner using blockchain. The smart contract 120 and the transaction data points associated with the loan of funds that may be provided to the vehicle 102 included within the smart contract 120 may be further verified through the blockchain technologies to complete secure loaning of funds from one or more financial accounts associated with the loan entity to the secure wallet 108 of the vehicle 102. Accordingly, the vehicle transaction application 106 may ensure that the vehicle transaction is secure from an initiation loan request point to a final loan fulfillment point through the use of blockchain.

In one or more embodiments, with respect to a repayment of the loan from the vehicle 102 to the loan entity, the smart contract processing module 204 may be configured to process a smart contract 120 associated with the repayment of the loan as a secure transaction between the vehicle 102 and the loan entity as a recipient of funds from the vehicle 102. The secure key execution module 206 may generate a secure key 110a that is associated with the loan entity as a recipient and a secure key 110b that is associated with the vehicle 102 and may pass the secure keys 110a, 110b for secure authentication of the repayment of the loan as a secure transaction. The secure transaction execution module 208 may thereby pass the smart contract 120 to the loan entity as a secure transaction using blockchain.

The smart contract 120 may be further verified through the blockchain technologies to complete secure repayment of the loan funds from the secure wallet 108 of the vehicle 102 to one or more financial accounts associated with the loan entity. It is appreciated that the methods 300 and 400 include non-limiting exemplary illustrative embodiments of particular types of secure transactions that may be facilitated through the vehicle transaction application 106. It is also appreciated that the vehicle transaction application 106 may execute similar processes to complete additional types of transactions (e.g., receiving payments from third-parties, payment of operating costs, and/or payment of transporting costs).

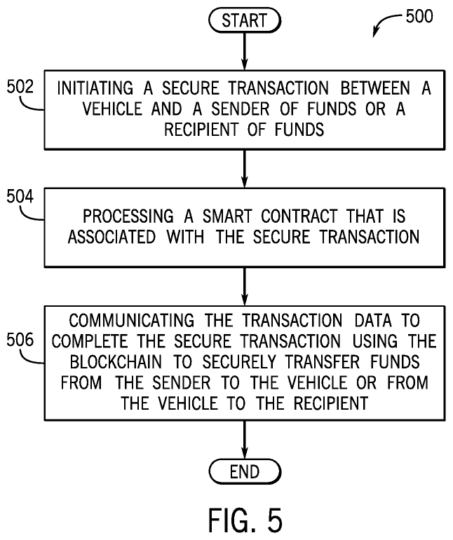

FIG. 5 is a process flow diagram of a method 500 for securing a vehicle transaction within blockchain according to an exemplary embodiment of the present disclosure. FIG. 5 will be described with reference to the components of FIG. 1 and FIG. 2, through it is appreciated that the method 500 of FIG. 5 may be used with additional and/or alternative system components. The method 500 may begin at block 502, wherein the method 500 may include initiating a secure transaction between a vehicle 102 and a sender of funds or a recipient of funds.

The method 500 may proceed to block 504, wherein the method 500 may include processing a smart contract 120 that is associated with the secure transaction. The method 500 may proceed to block 506, wherein the method 500 may include communicating the transaction data to complete the secure transaction using the blockchain to securely transfer funds from the sender to the vehicle 102 or from the vehicle 102 to the recipient.

It should be apparent from the foregoing description that various exemplary embodiments of the disclosure may be implemented in hardware. Furthermore, various exemplary embodiments may be implemented as instructions stored on a non-transitory machine-readable storage medium, such as a volatile or non-volatile memory, which may be read and executed by at least one processor to perform the operations described in detail herein. A machine-readable storage medium may include any mechanism for storing information in a form readable by a machine, such as a personal or laptop computer, a server, or other computing device. Thus, a non-transitory machine-readable storage medium excludes transitory signals but may include both volatile and non-volatile memories, including but not limited to read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

It will be appreciated that various implementations of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A computer-implemented method for securing a vehicle transaction within blockchain comprising:
initiating a secure transaction between a vehicle and a sender of funds or a recipient of funds;
processing a smart contract that is associated with the secure transaction, wherein the smart contract includes transaction data that is associated with the secure transaction; and
communicating the transaction data to complete the secure transaction using the blockchain to securely transfer funds from the sender to the vehicle or from the vehicle to the recipient.

2. The computer-implemented method of claim 1, wherein the vehicle is independently financially sourced to receive funds from the sender and to send funds to the recipient, wherein the vehicle includes a vehicle secure wallet that is configured as a virtual secure account that stores an amount of funds that are associated with the vehicle.

3. The computer-implemented method of claim 1, wherein initiating the secure transaction includes presenting a transaction initiation user interface that is presented to the sender to initiate the secure transaction to securely transfer an amount of funds to the vehicle, wherein the secure transaction includes at least one of: a reservation transaction, a loan transaction, and a payment transaction.

4. The computer-implemented method of claim 1, wherein initiating the secure transaction includes facilitating the sending of funds to the recipient to facilitate a payment of at least one: operating costs to maintain operating standards of the vehicle, transporting costs to maintain transporting standards of the vehicle, funds to an ownership entity that owns the vehicle, and repayment of a loan that has been provided to the vehicle.

5. The computer-implemented method of claim 1, wherein the smart contract is configured as a self-executing contract that includes terms of agreement that are associated with a transfer of funds from the sender to the vehicle or from the vehicle to the recipient, wherein the smart contract includes an amount associated with the transfer of funds.

6. The computer-implemented method of claim 1, further including generating a first secure key that is associated with the vehicle and a second secure key that is associated with at least one of: the sender and the recipient, wherein the first secure key and the second secure key are exchanged for secure authentication of the secure transaction between the sender and the vehicle or the vehicle and the recipient.

7. The computer-implemented method of claim 1, wherein communicating the transaction data to complete the secure transaction includes passing the smart contract through a blockchain computing infrastructure to complete the secure transaction through blockchain in an encrypted and secure manner.

8. The computer-implemented method of claim 1, further including presenting a reservation user interface to a user to enable the user to reserve and utilize the vehicle for a particular period of time, wherein transaction data associated with the reservation and utilization of the vehicle are collected and analyzed to calculate a usage fee that is included within the smart contract to be paid to the vehicle, wherein funds associated with the usage fee are securely transferred to the vehicle through the blockchain.

9. The computer-implemented method of claim 1, further including analyzing a current amount of funds of the vehicle to determine if a requisite amount of funds are available for the vehicle to self-operate in order to facilitate payment of operating costs and transporting costs.

10. A system for securing a secure key transaction within blockchain comprising:
a memory storing instructions when executed by a processor cause the processor to:
initiate a secure transaction between a vehicle and a sender of funds or a recipient of funds;
process a smart contract that is associated with the secure transaction, wherein the smart contract includes transaction data that is associated with the secure transaction; and
communicate the transaction data to complete the secure transaction using the blockchain to securely transfer funds from the sender to the vehicle or from the vehicle to the recipient.

11. The system of claim 10, wherein the vehicle is independently financially sourced to receive funds from the sender and to send funds to the recipient, wherein the vehicle includes a vehicle secure wallet that is configured as a virtual secure account that stores an amount of funds that are associated with the vehicle.

12. The system of claim 10, wherein initiating the secure transaction includes presenting a transaction initiation user interface that is presented to the sender to initiate the secure transaction to securely transfer an amount of funds to the vehicle, wherein the secure transaction includes at least one of: a reservation transaction, a loan transaction, and a payment transaction.

13. The system of claim 10, wherein initiating the secure transaction includes facilitating the sending of funds to the recipient to facilitate a payment of at least one: operating costs to maintain operating standards of the vehicle, transporting costs to maintain transporting standards of the vehicle, funds to an ownership entity that owns the vehicle, and repayment of a loan that has been provided to the vehicle.

14. The system of claim 10, wherein the smart contract is configured as a self-executing contract that includes terms of agreement that are associated with a transfer of funds from the sender to the vehicle or from the vehicle to the recipient, wherein the smart contract includes an amount associated with the transfer of funds.

15. The system of claim 10, further including generating a first secure key that is associated with the vehicle and a second secure key that is associated with at least one of: the sender and the recipient, wherein the first secure key and the second secure key are exchanged for secure authentication of the secure transaction between the sender and the vehicle or the vehicle and the recipient.

16. The system of claim 10, wherein communicating the transaction data to complete the secure transaction includes passing the smart contract through a blockchain computing infrastructure to complete the secure transaction through blockchain in an encrypted and secure manner.

17. The system of claim 10, further including presenting a reservation user interface to a user to enable the user to reserve and utilize the vehicle for a particular period of time, wherein transaction data associated with the reservation and utilization of the vehicle are collected and analyzed to calculate a usage fee that is included within the smart contract to be paid to the vehicle, wherein funds associated with the usage fee are securely transferred to the vehicle through the blockchain.

18. The system of claim 10, further including analyzing a current amount of funds of the vehicle to determine if a requisite amount of funds are available for the vehicle to self-operate in order to facilitate payment of operating costs and transporting costs.

19. A non-transitory computer readable storage medium storing instructions that when executed by a computer, which includes a processor perform a method, the method comprising:
initiating a secure transaction between a vehicle and a sender of funds or a recipient of funds;
processing a smart contract that is associated with the secure transaction, wherein the smart contract includes transaction data that is associated with the secure transaction; and
communicating the transaction data to complete the secure transaction using the blockchain to securely transfer funds from the sender to the vehicle or from the vehicle to the recipient.

20. The non-transitory computer readable storage medium of claim 19, wherein the vehicle is independently financially sourced to receive funds from the sender and to send funds to the recipient, wherein the vehicle includes a vehicle secure wallet that is configured as a virtual secure account that stores an amount of funds that are associated with the vehicle.
